(19) United States
(12) Patent Application Publication
(10) Pub. No.: US 2008/0300856 A1
(43) Pub. Date: Dec. 4, 2008

(54) System and method for structuring information

(75) Inventors: Randal J. Kirk, Belspring, VA (US); Julian P. Kirk, Radford, VA (US); Eric Lieberman, Essex, CT (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Talkflow Systems, LLC

(21) Appl. No.: 10/945,428

(22) Filed: Sep. 21, 2004

Related U.S. Application Data
(63) Continuation-in-part of application No. 09/956,990, filed on Sep. 21, 2001, now Pat. No. 6,912,272.

(51) Int. Cl. G06F 17/28

(52) U.S. Cl. 704/4

(57) ABSTRACT

A translational language system and method for structuring irregular, or unstructured, information are provided. The language system comprising at least one compulsory characteristic for defining a particular nuance of an irregular communication; and at least one term or phrase corresponding to the at least one compulsory characteristic for further defining the particular nuance of the irregular communication.

### CROSS-REFERENCE TO RELATED APPLICATION(S)

The present patent application is a continuation-in-part of a previously filed utility patent application entitled “Method and Apparatus for Managing Communications and for Creating Communication Routing Rules,” filed Sep. 21, 2001, as U.S. patent application Ser. No. 09/956,990. This patent application claims the benefit of the filing date of the cited utility patent application according to the statutes and rules governing utility patent applications. The specification and drawings of the preceding application is specifically incorporated herein by reference.

This application is also related to the following previously filed utility patent applications: (1) “Method and Apparatus for Facilitating Handling of Communications,” filed Apr. 12, 2002, as U.S. patent application Ser. No. 10/121,477; (2) “Method and Apparatus for Facilitating Handing of Communications,” filed Sep. 16, 2002, as PCT Application No. PCT/US02/29216; and (3) “Method and Apparatus for Facilitating Handling of Objects,” filed Apr. 14, 2003, as PCT Application No. PCT/US03/11385. The specification and drawings of the preceding three applications are specifically incorporated herein by reference.

### FIELD OF THE INVENTION

The invention relates generally to a system and method for structuring information, and more particularly to a system and method for structuring information consistently using a meta (or translational) language system.

### BACKGROUND OF THE INVENTION

Humans have the inherent ability to efficiently and accurately interpret information. Humans effectuate this ability by utilizing their command of language to define or express meaning. While the absolute “meaning” of given information (such as an object, for example) may be theoretically constant, the expression of that meaning varies with the particular language used. For instance, the words “car” and “wheels” can comprise two expressions of the same object, the former being standard English and the latter being an example of synecdoche in youthful slang. Jumping from one expression to another (i.e., translation) among a virtually infinite universe of potential phrasings is a skill that humans are very good at.

This capability is in part a result of what is perhaps the most important difference between human communication and that of machine-based systems or other animals—that human language is inherently recursive. Recursion, as it applies to human language, confers the ability upon humans to produce an apparently unbounded complexity and diversity of meaning, despite the finite nature of our memory and computational resources we have at our disposal. Conversely, the ability to translate this infinity of variation into useful information is an essential requirement of human language understanding, and as such, is rarely considered explicitly to be the amazing ability that it certainly is.

In the examples of recursion below, note the arbitrary complexity of the recursive constructs.
(1) The dog the boy kicked barked.
(2) Jane's father's company's health plan's prescription coverage is great.
(3) Dave said that Billy watched Stan encourage Phil to cheat on his test.
(4) The traditional nursery rhyme The House that Jack Built whose last verse begins: This is the farmer sowing his corn, That kept the cock that crowed in the morn, That waked the priest all shaven and shorn, That married the man all tattered and torn, . . . and so on.

Humans are also able to assess or refine meaning based on nuances incidental to the information itself, such as context, tone or mood, for example. For instance, the tone of a speaker's voice may influence the meaning of his or her speech, while the color of the paper on which a report is printed, or the orientation or placement of the text thereon, may reveal particulars about its content and/or the author. Recently, the field of “computational linguistics” has been explored in a theoretical nature. In computational linguistics, the formal techniques of computational models of intelligence are applied to the study of human linguistics. It has been proposed that all language is faded metaphor, and that it is a unique human ability to construct the world as it is revealed through language. The ability to categorize parts of phrases to select a specific overall meaning from the constituent parts of the phrases or sentences seems to be characteristic of human behavior uniquely. The continuous refinement and redefinition of what role an object plays in our environment, and how we conceptualize that object as having different properties in different contexts is known as the process of “cocomposition.”

Humans may also resolve word ambiguity, which all words suffer from to some extent. Even words that appear to have one fixed sense can exhibit multiple meanings in different contexts. ‘Room’, for example, can mean a physical object or the spatial enclosure defined by this object. The conceptual relation between two senses of the same word is referred to as “logical polysemy.” Further, the concept of “metonymy,” in which a figure of speech involving the substitution of one noun for another of which it is an attribute or which is closely associated with it, renders language highly complex to understand. Examples of metonymy are “the kettle boils” or “he drank the cup.” Because language is highly complex and the full understanding of language is uniquely human (or at least requires a tremendous amount of processing power), previous attempts to automate the routing of communications and interpretations of meaning have failed to ascertain context and other incidents and thus cannot accurately handle a communication or accurately interpret meaning without a great deal of human intervention.

However, human ability to interpret and translate is not limitless. Vocabulary, for example, is a significant impediment. Each language requires familiarity with thousands upon thousands of words and phrases, each of which, as we have seen, may mean different things depending on context, mood or tone. Thus, a monolingual skilled in English is unable to translate information into Italian, for example, while a bilingual is limited to translating meaning between the two languages known. Further complicating matters is the fact that vocabulary is further associated with (i.e., compartmentalized within) three categories (or parts of speech), namely subject, verb and object, for example.

Extensive vocabulary may also lead to inconsistent interpretations or translations. For example, three individuals fluent in English may interpret a particular communication or information differently. The same object, for example, may be referred to as a “car,” “vehicle,” or “automobile.” While these three expressions mean the same thing to humans, they may appear indecipherable, unintelligible, or unstructured to automated systems or computers, thus diminishing their value and efficacy.

In his 1957 book Syntactic Structures, Noam Chomsky demonstrated that language can, in principal, be characterized by a set of generative rules. In addition, he argued that Natural Languages cannot be accounted for by a finite state automation, because the latter can only produce regular languages.

Thus, there is a need for a system and method that solves the problems inherent to processing of unstructured information by automated information processing systems, i.e., inaccessibility of information, unintelligibility, inability to systematize, inability to respond uniformly, and other similar deficiencies.

### SUMMARY OF THE INVENTION

An object of the present invention is to overcome the aforementioned and other drawbacks existing in prior art systems and methods.

Another object of the present invention is to provide a system and method that coordinates the relationship between vocabulary and compulsory characteristics (or parts of speech) of a meta language system, for example, in such a way as to facilitate the structuring (e.g., translation or interpretation) of unstructured information by a live human agent operating in conjunction with an automated information processing system.

Another object of the invention is to provide a system and method that takes advantage of a human agent's ability to process and understand infinite recursive human communication and translate that communication into a standardizing language usable by automated processes and intelligible in the aggregate.

Another object of the invention is to provide a meta (or translational) language system for use with any information processing system, manual or automated, to facilitate translation of information into a finite set of characteristics, which, in the aggregate, represent an accurate (or organizationally relevant) translation of the information.

Another object of the invention is to provide a system and method that permits creation of languages which aim to consistently structure unstructured information in an organizationally relevant format.

Another object of the invention is to provide a language that winnows irregular information (such as an incoming communication, for example) down to a set of values in the format of a predetermined number of characteristics, or parts of speech, which, in combination, capture the organizationally relevant meaning(s) of the incoming communication.

Another object of the invention is provide a system and method that enables quick mastery of a translation language by a user, such as a call center agent, for example, and thus promotes ease of handling, systemization, and intelligibility of finished translation products.

Yet another object of the invention is to provide a language that comprises a predetermined number of categories into which vocabulary may be compartmentalized.

Another object of the invention is to provide a permutative system and method that enables selective dimensioning of potential translations.

Yet another object of the invention is to provide a meta (or translational) language system that may mine and structure unstructured information/data.

According to one embodiment of the invention, a translation language for structuring irregular information is provided. The system comprises at least one compulsory characteristic for defining a particular nuance of an irregular communication; and at least one term or phrase corresponding to the at least one compulsory characteristic for further defining the particular nuance of the irregular communication.

In another embodiment of the invention, a system for structuring information is provided. The system comprises: means for encountering information; and means for structuring the information by translating or interpreting it using a translation language.

In yet another embodiment of the invention, a process for structuring unstructured information is provided. The system comprises: receiving unstructured information; and structuring the unstructured information by translating it using a translation language, the translation language comprising a predetermined number of compulsory characteristics relating to particular nuances of the unstructured information.

In another embodiment of the invention, a process for structuring information is provided. The process comprising: receiving information content in a first language; and translating the information content to a second language by associating at least one particular nuance of the information's content to at least one part of the speech of the second language.

In yet another embodiment of the invention, a method for structuring communication/information is provided. The method comprising: receiving information/communication in a first language; translating the information/communication to a predetermined and/or finite number of characteristics in a second language based on the information/communication's content; and structuring the information/communication based on the particular combination of characteristics.

In another embodiment of the invention, a process for translating an incoming communication is provided. The process comprising: receiving a communication; winnowing the communication down to a predetermined number of characteristics using a translation language, the translation language comprising a predetermined number of organizationally relevant compulsory characteristics relating to particular nuances of the unstructured information; and determining the meaning of the incoming communication based on the predetermined number of organizationally relevant compulsory characteristics.

In another embodiment of the invention, a method for translating incoming communications is provided. The method comprising: receiving an incoming communication; forwarding the incoming communication to a live operator for translation; and learning how to translate similar incoming communications in the future using a translation language. In some embodiments, the incoming communication may be received by an automated system or by a live agent each of which is able to forward the communication to a live agent who is able to translate the communication. In either case, subsequent translations of similar communications—whether done automatically by an automated system, or by a live agent—may be based on the live operator's prior resolution of similar incoming communications.

In another embodiment of the invention, a process for structuring information is provided. The process comprising: encountering unstructured information; determining whether the unstructured information is processable; forwarding the information to a live agent for processing using a translational language; and learning how to process similar unstructured information in the future, whether via automated or live agent processing, based on the original live agent's resolution.

In yet another embodiment of the invention, a method for processing incoming communications is provided. The method comprising: receiving one or multiple incoming communications containing or comprised of unstructured information; translating all or a certain percentage of the incoming communications using a human agent or human agents utilizing a translation meta language, the translation meta language comprising a predetermined number of compulsory characteristics relating to particular nuances of the unstructured information; assessing how the incoming communication has been or is being processed by the human agent or agents; and refining all or part of the automated translation system based on such assessment.

In another embodiment of the invention, a method for structuring information is provided. The method comprises: encountering unstructured information; translating all or part of the unstructured information; and refining the translation of all or part of the unstructured information based on a live agent's translation of all or part of the unstructured information.

In another embodiment of the invention, a method for translating recursive information is provided. The method comprises: encountering recursive information; translating all or part of the recursive information; and refining the translation of all or part of the recursive information based on a live agent's translation of all or part of the recursive information.

In yet another embodiment of the invention, a method for structuring information is provided. The method comprising: encountering audio or visual information; and translating all or part of the audio or visual information using a translation language.

In still another embodiment of the invention, a method for systematically describing and structuring information is provided. The method comprising: encountering audio or visual information; and describing or classifying the said information using a meta (or translational) language system in order to improve accessibility and utility of said information.

In yet another embodiment of the invention, a system for structuring information is provided. The system comprising: means for encountering audio or visual information; and means for translating all or part of the audio or visual information using a translation language.

In another embodiment of the invention, a method for processing a search request is provided. The method comprising: receiving a request for information from a user; translating the request for information into an organizationally relevant format; resolving the organizationally relevant format against a database of information; and providing the user with information responsive to the request for information.

In still another embodiment of the invention, a system for processing information is provided. The system comprising: a reception module for receiving incoming audio or visual information; and a translation module for translating the incoming audio or visual information using a translation language.

In another embodiment of the invention, a system for processing a request for information is provided. The system comprising: a reception module for receiving a request for information; and a refining module for refining the search request to an organizationally relevant format using a translation language.

According to various embodiments, the invention utilizes the human's immense capability for natural language processing and understanding while still taking advantage of the advantages of automated systems—speed, auditability, and scale.

By marrying the inherent human ability to process recursive natural human language with the complementary benefits of automated information processing systems, the various embodiments of the invention may improve the efficiency of known information processing systems.

The accompanying drawings, which are incorporated in and constitute a part of this specification, illustrate various embodiments of the invention and, together with the description, serve to explain the principles of the invention.

### BRIEF DESCRIPTION OF THE DRAWINGS

FIG. 1 is a process flow illustrating a method for translating or interpreting information or communications, according to one embodiment of the invention.

FIG. 2 is a process flow illustrating a method for translating or interpreting information or communications, according to one embodiment of the invention.

FIG. 3 is a block diagram illustrating a meta (or translation) language system 300, according to one embodiment of the invention.

FIG. 4 is a block diagram illustrating a meta (or translational) language system 300, according to one embodiment of the invention.

FIG. 5 is a block diagram of the compulsory nature of meta (or translation) language system 300, according to one embodiment of the invention.

FIG. 5a is a schematic representation of a meta (or translational) language system of FIG. 3 being used to structure unstructured information, according to one embodiment of the invention.

FIG. 6 illustrates an information processing system using a meta (or translation) language system, according to one embodiment of the invention.

FIG. 7 is a block diagram of the server element of the information processing system of FIG. 6.

FIG. 8 is a block diagram illustrating one embodiment of an information processing system utilizing both live human interaction and automated systems.

FIG. 9 is a process flow diagram of exception handling, according to one embodiment of the invention.

FIG. 10 is a process flow diagram of contemporaneous handling (or sampling), according to one embodiment of the invention.

FIG. 11 is a schematic representation of the collaborative effort comprising exception handling and contemporaneous handling (or sampling), according to one embodiment of the invention.

### DETAILED DESCRIPTION OF THE INVENTION

Reference will now be made to the present preferred embodiments of the invention, examples of which are illustrated in the accompanying drawings in which like reference characters refer to corresponding elements.

The present invention is primarily described in relation to a system and method for translating incoming information or communications using a meta (or translational) language in the context of a call center, receptionist station, or other information processing system. Nonetheless, the characteristics and parameters pertaining to the system and method may be applicable to translations or interpretations associated with other types of content, such as using the system and method of meta (or translational) language to structure unstructured data in conjunction with data mining techniques.

While the exemplary embodiments illustrated herein may show the various embodiments of the invention collocated, it is to be appreciated that the various components of the various embodiments may be located at distant portions of a distributed network, such as a local area network, a wide area network, a telecommunications network, an intranet and/or the Internet, or within a dedicated object handling system. Thus, it should be appreciated that the components of the various embodiments may be combined into one or more devices or collocated on a particular node of a distributed network, such as a telecommunications network. As will be appreciated from the following description, and for reasons of computational efficiency, the components of the various embodiments may be arranged at any location within a distributed network without affecting the operation of the respective system.

According to one embodiment, a technical effect of the invention is the provision of a meta (or translational) language system that is composed or constructed in such a way as to achieve consistency in translation by vigorously applying the meta (or translational) language system to the communications or information. Consistency is achieved, for example, irrespective of which agent receives an incoming call in a call center, for example. In one embodiment, the meta (or translational) language system may comprise a meta language comprising a predetermined relationship between a predetermined number of characteristics (or parts of speech) and a predetermined number of corresponding vocabulary.

The invention may also comprise a system and method that interprets irregular communications by facilitating their translation into a predetermined and finite set of characteristics, which, in the aggregate, represent an accurate translation or interpretation of the particular irregular communication. Irregular information may comprise any information or content. The system and method may be used in any circumstance requiring interpretation of information into an organizationally relevant and manageable form. The system and method of the invention may also translate based on nuances of the information or communication, such as context, tone or mood, for example. Other nuances are possible.

Several embodiments of the invention may be used, for example, in connection with operation of a call center, or any other type of manual or automated information processing system. In the call center embodiment, for example, the invention may be used to assist an agent of the call center with translating call requests into a standardized and organizationally relevant format, which may comprise a predetermined number of characteristics and a predetermined number of corresponding terms or phrases, for example. The agent may, for example, assess and ascertain various characteristics or nuances of a communication, such as a telephone call, wherein each of the characteristics or nuances may compulsively contribute to at least one organizationally relevant meaning or significance. In one embodiment, the invention may comprise a meta (or translational) language system structured in such a way as to ensure consistency of interpretation from agent to agent. That is, irrespective of which agent is handling the call, the meta (or translational) language system will compulsively translate or interpret the call into an organizationally relevant format, such as designating a particular destination, for example. In one embodiment, the meta (or translational) language system may comprise a strict syntax so as to ensure consistency in translation. That is, the meta (or translational) language system may comprise a predetermined number of compulsory characteristics which a human agent may resolve in order to provide organizationally relevant meaning.

The various embodiments of the invention described herein may be used in isolation to translate or interpret information, or in conjunction with any system or method which operates to receive, process, and transmit information. In particular, systems and methods which assess and translate information may benefit from incorporation of the meta (or translation) language systems described herein. Indeed, any system or method which functions to present, display, transmit, receive, relay, exchange, communicate, and/or process information, may benefit from any number of the embodiments described herein. Such systems include presentation of information on web pages, over networks, message boards, and any other form of presenting information, electronic or otherwise.

Various aspects or embodiments of the invention will now be discussed.

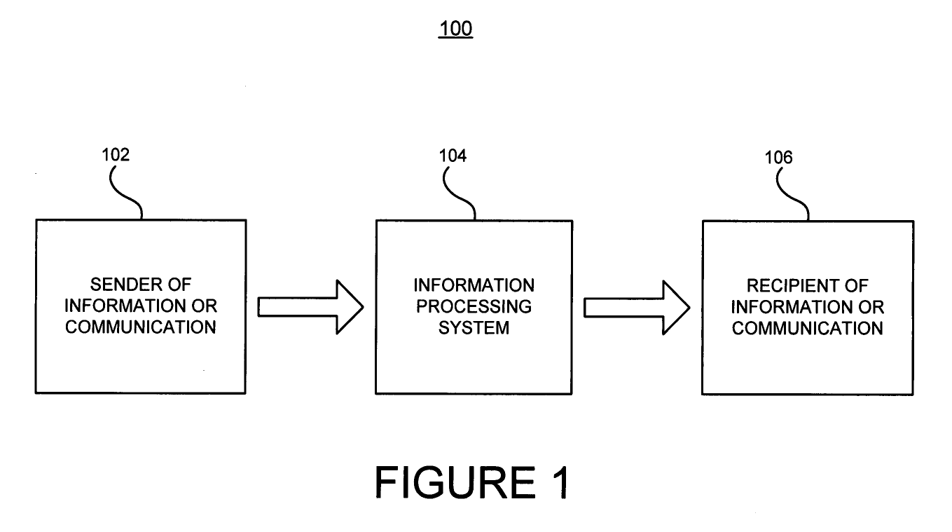

FIG. 1 is a process flow illustrating a method 100 for translating or interpreting information or communications, according to one embodiment of the invention. At step 102, information or communication is transmitted or sent by a sender, who may comprise any individual or entity, for example. At step 102, the information or communication is received and processed by an information processing system 104, which may comprise, for example, a customer service or receptionist station for receiving customer calls of a particular business. In such an embodiment, the information processing conducted may determine or administer the directing of incoming calls to their appropriate destination(s), for example. Other forms of processing are of course possible.

In one embodiment, information processing system 104 may comprise (or operate in conjunction with), a meta (or translational) language system for translating or interpreting the information or communication. Such a meta (or translational) language system may comprise a predetermined relationship between vocabulary and parts of speech (or characteristics), which, in the aggregate, give rise to a predetermined number of potential translations, each of which relates organizationally relevant meaning. Preferably, the relationship between vocabulary and characteristics is such that a user of the meta (or translational) language may readily translate or interpret information (i.e. give organizationally relevant meaning to), without the need for extensive memorization, for example.

According to one embodiment, information or communication which may be translated using the meta (or translational) language system may comprise or include any form of translatable information or communication, to include any object, which may be defined as any physical device, as well as any type of non-tangible or electronic information or communication including electrical signals, such as a telephone call, e-mail, data, electronic documents, or the like. Specifically, the object can be a phone call(s), mail, any type of content, an electronic or physical document(s), information, such as information associated with a response management system, information associated with a customer relations management system, a routing system, or the like.

At step 106, the appropriate recipient(s), if any, may receive the information or communication. In one embodiment, the information or communication may be received in translated, proper, or decipherable form (e.g., in an organizationally relevant form) to facilitate proper processing by the recipient. For example, a business recipient—such as the purchasing department of a manufacturer, for example—may receive the information or communication in a translation language which compulsively presents organizationally relevant characteristics of the original information or communication, for example. For instance, meta (or translation) language system may comprise a predetermined number of organizationally relevant characteristics (or parts of speech) which particularly relate to at least one organizationally relevant nuance of the information or communication.

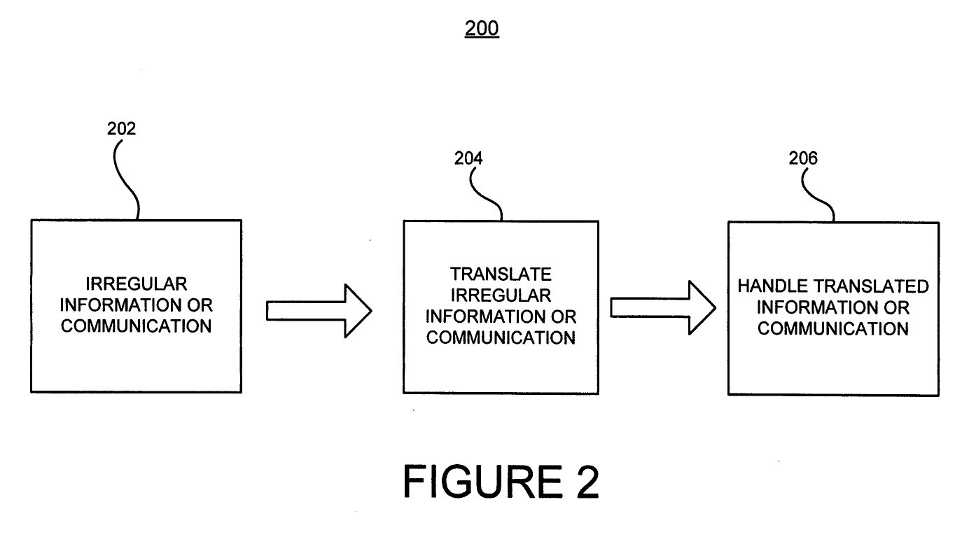

FIG. 2 is a process flow illustrating a method 200 for translating or interpreting irregular information or communications, according to one embodiment of the invention. At step 202, information processing system 104, for example, may encounter irregular information or communication. Irregular information or communication may comprise, for example, an incoming phone call to a call center. In another embodiment, irregular information or communication may comprise unstructured data stored in a database, for example. Other forms of irregular information are, of course, possible. At step 204, the irregular information or communication may be translated by information processing system 104. In one embodiment, the information or communication is translated using a meta (or translation) language system, which may be composed in such a way as to ensure consistent, reliable, and organizationally relevant interpretation. In one embodiment, consistent and reliable interpretations and translations may be achieved through applying a translational language system comprised of a predetermined relationship between a predetermined number of organizationally relevant characteristics and corresponding vocabulary. At step 206, the translated information or communication may then be handled efficiently by the recipient according to predetermined business rules, for example.

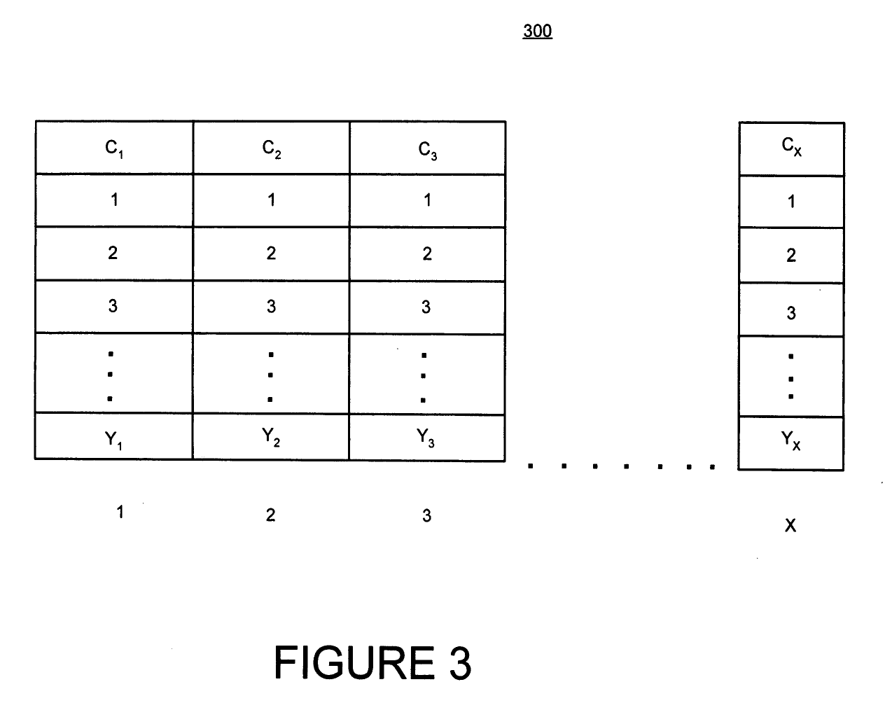

FIG. 3 is a block diagram illustrating a meta (or translation) language system 300, according to one embodiment of the invention. In one embodiment, meta (or translational) language system 300 may comprise (or operate in conjunction with), information processing system 104 disclosed in FIG. 1. In one embodiment, meta (or translational) language 300 may comprise a module or algorithm which functions to automatically (or with live human intervention) assess and give organizationally relevant meaning to unstructured information.

As shown, meta (or translational) language system 300 may comprise a predetermined number of characteristics (C₁, C₂, C₃, . . . , Cₙ), or parts of speech, which, in one embodiment, may relate to particular nuance(s) of an information or communication's meaning. That is, each characteristic may relate to a particular aspect or feature of meaning that is relevant or important to accurate and efficient processing by the recipient of the translated information or communication, for example. Such aspects or features may be outwardly apparent, such as the sender or intended recipient of the information or communication, or may include incidental aspects or features such as the context, tone or mood in which the information is sent, presented or received, for example.

Meta (or translational) language 300 may also comprise predetermined vocabulary corresponding to the predetermined number of characteristics (C₁, C₂, C₃, . . . , Cₙ). As shown, such predetermined vocabulary is designated in the respective columns (1-Y₁, 1-Y₂, 1-Y₃, . . . 1-Y_{X}) under the predetermined number of characteristics (C₁, C₂, C₃, . . . , Cₙ). Each characteristic may have a corresponding unique vocabulary set, such as (1-Y₁, 1-Y₂, 1-Y₃, . . . , 1-Y_{X}), for example, designating particular vocabulary terms or phrases. Also, each characteristic may have a unique number of vocabulary terms or phrases. That is, Y₁, Y₂, Y₃, . . . Y_{X} may comprise the same or different number of vocabulary terms or phrases. In one embodiment, the predetermined relationship between the predetermined number of characteristics (C₁, C₂, C₃, . . . , Cₙ) and their corresponding unique vocabulary sets (1-Y₁, 1-Y₂, 1-Y₃, . . . 1-Y_{X}), dimensions a particular number of potential translations or interpretations, for example.

In one embodiment, system 300 may facilitate interpretation or translation of irregular information or communications, for example, by reducing or enabling the reduction of the irregular information or communications into a predetermined and/or finite set of characteristics, (i.e., C₁, C₂, C₃, . . . , Cₙ), which when viewed together represent an accurate (or organizationally relevant) translation or meaning of the irregular information or communication. In one embodiment, the reduction of an irregular communication's meaning into a finite set of characteristics is accomplished by a live human agent who selectively defines the individual characteristics (i.e., C₁, C₂, C₃, . . . , Cₙ). In other embodiments, such reduction may be done by an automated system, for example.

The granularity of meta (or translational) language system 300 may be predetermined based on the potential translations desired. That is, the multiple characteristics (C₁, C₂, C₃, . . . , Cₙ), or parts of speech, in system 300 may, in one embodiment, leverage the concept of exponential growth of potential combinations to overcome the limitations of a dramatically reduced vocabulary. That is, with just a 5 word vocabulary and 8 parts of speech, over 390,000 (or 5⁸) combinations are possible. A reduced vocabulary, in turn, enables the quick mastery by the language system's users, as well as ease of handling, systematization, and intelligibility of the finished translation products. Each characteristic may be thought of as a part-of-speech (or variable) that is compulsory in nature (i.e. strict syntax) both in and of itself, as well as in combination with the other characteristics and its relation to them. The number of characteristics is predetermined by the particular incarnation of the translational language system, i.e., by the particular language (i.e., the predetermined relationship between characteristics and vocabulary) in effect in a given embodiment.

In one embodiment, meta (or translational) language system 300 winnows information or communications down to a predetermined number of characteristics, or parts-of-speech which, in combination, capture the organizationally relevant meaning of the incoming communication. In so doing, meta (or translational) language system 300 provides structure to the information, rendering the previously unstructured, polycontextual, highly complex, and organizationally-indecipherable information useful, known, tracked, and systematized. In effect, meta (or translational) language system 300 may reduce the vocabulary that needs to be learned by increasing the number of characteristics or parts-of-speech into which limited vocabulary may be compartmentalized. System 300 is permutative in that various forms of dimensioning characteristics and vocabulary are possible.

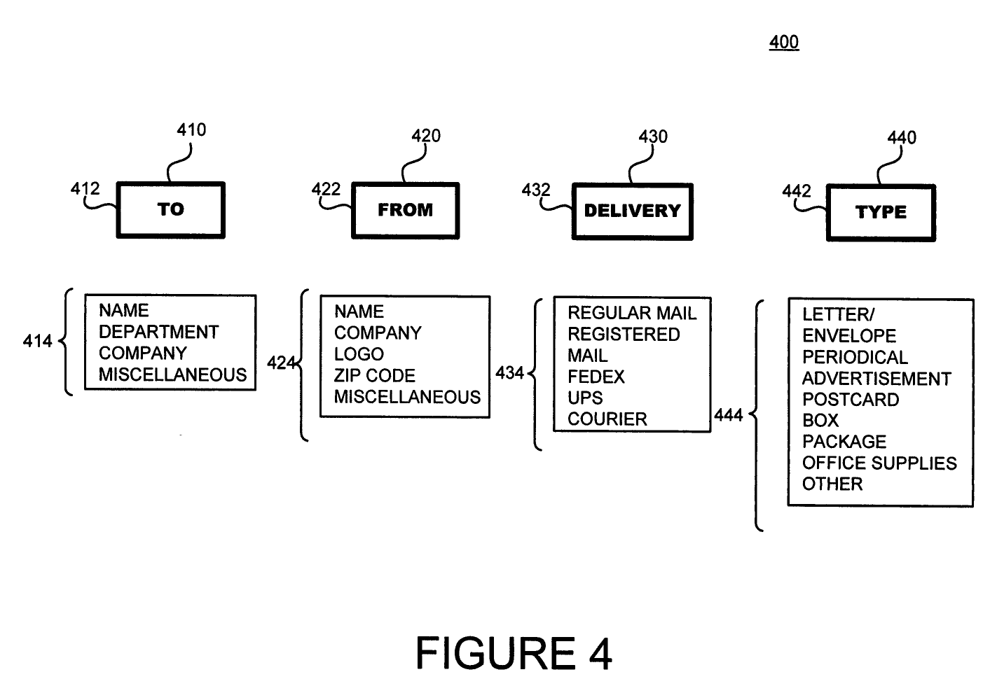

FIG. 4 illustrates an exemplary embodiment 400 for the meta (or translational) language system 300 above, for use in an information processing system for receiving incoming physical communications such as mail, for example. A plurality, four in the exemplary embodiment, of columns 410, 420, 430, and 440 are shown. Each of the columns represents a predefined communication characteristic (412, 422, 432, 442) and includes a plurality of values (414, 424, 434, 444) that can be assigned to the corresponding characteristic. Ascertainable characteristics of the physical communication, preferably those characteristics ascertainable from the exterior of the communication are used for assigning the values. The proper value for one or more of the characteristics can be assigned (manually, such as by a mail clerk, for example, or automatically, such as by an automated system or module that operates to assess characteristics of the communication) and the communication can be handled based on organizationally relevant predefined rules applied to the series of values i.e., the “value matrix.”

Column 410 has characteristics 412 that relate to the entity to which the communication is addressed. This information can be culled (manually or automatically) from the address label on the communication by scanning and character recognition, by human interpretation and/or input through a keyboard, for example. The potential values 414 associated with column 410 are NAME, DEPARTMENT, COMPANY, and MISCELLANEOUS. For example, if a letter received is addressed to “Attention Sales Department,” the value assigned to column 410 will be DEPARTMENT and the specific department, i.e., Sales Department may be saved as an attribute for subsequent processing. For example, optical scanning and character/word recognition can be used to determine the content of the address label.

Column 420 has characteristics 422 that relate to the originator of the communication, i.e. the person who sent the letter. The potential values 424 associated with column 422 are NAME, COMPANY, LOGO, ZIP CODE, AND MISCELLANEOUS. For example, if the return address label or letter heading does not have an individual's name but includes a company name, the value assigned to column 420 will be COMPANY.

Column 430 has characteristic 432 that relates to the delivery method of the communication, e.g., the package carrier or service in the exemplary embodiment. The potential values 434 associated with column 430 are REGULAR MAIL, REGISTERED MAIL, FEDERAL EXPRESS™, UNITED PARCEL SERVICE™, and COURIER (such as a local package courier service or other miscellaneous delivery service). Of course, the value 434 assigned to characteristic 432 of the exemplary embodiment corresponds directly to the delivery service that can be ascertained from the mailing label or other indicia on the package.

Column 440 has characteristic 442 that relates to the type of communication, i.e. letter, periodical, and the like. The potential values 444 associated with column 440 are LETTER, ENVELOPE, PERIODICAL, ADVERTISEMENT, POSTCARD, BOX, PACKAGE, OFFICE SUPPLIES, and OTHER. Once again, the value assigned to column 440 can correspond to the type of communication which can be ascertained from a visual inspection and input manually or automatically into the system.

It can be seen that the values assigned to the characteristics provide a great deal of information without the need to open the communication and thus can provide direction in handling the communication. Of course, there can be any number of characteristics and corresponding values to effect the sorting procedure in accordance with appropriate business rules. Also, the characteristics and values can be predetermined based on the type of business, the organizational flow of the business, the number of employees, the division of work, and the like. The characteristics can relate to any aspect of a potential communication, and there can be any number or type of values for selection in each characteristic. The attributes discussed above could be used as values. For example, one set of selectable values could include each employee of a company.

Similarly, it can be appreciated that various embodiments of the present invention are able to process more complex or esoteric forms of incoming or encountered information. That is, various embodiments are able to deduce nuanced meaning(s) from unstructured information using polysemy or other advanced forms of translation/interpretation, for example.

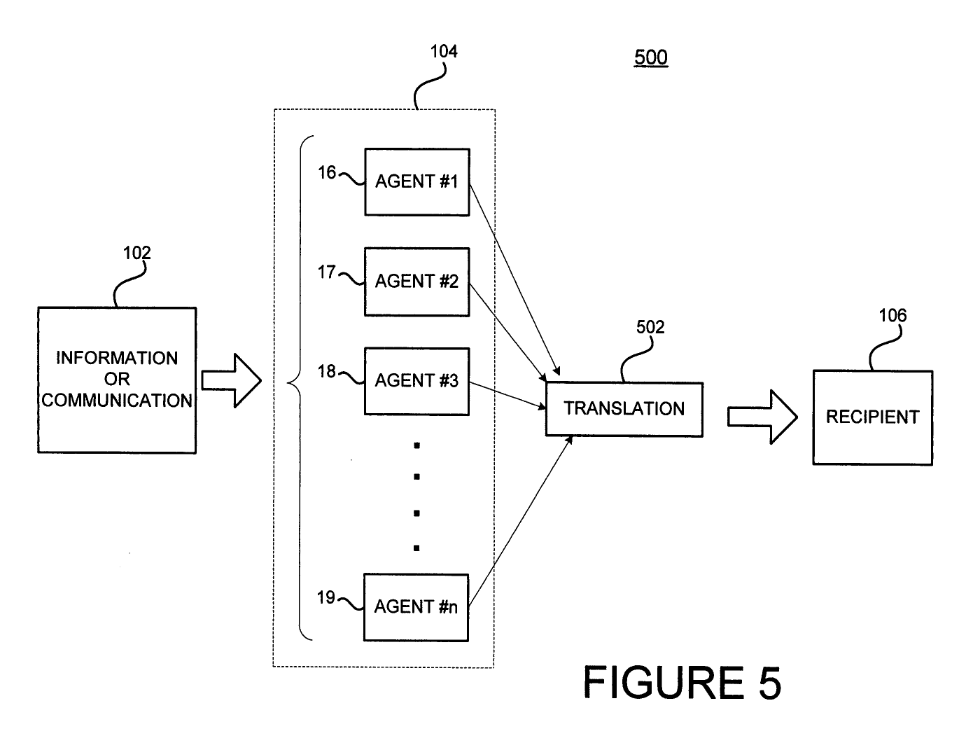

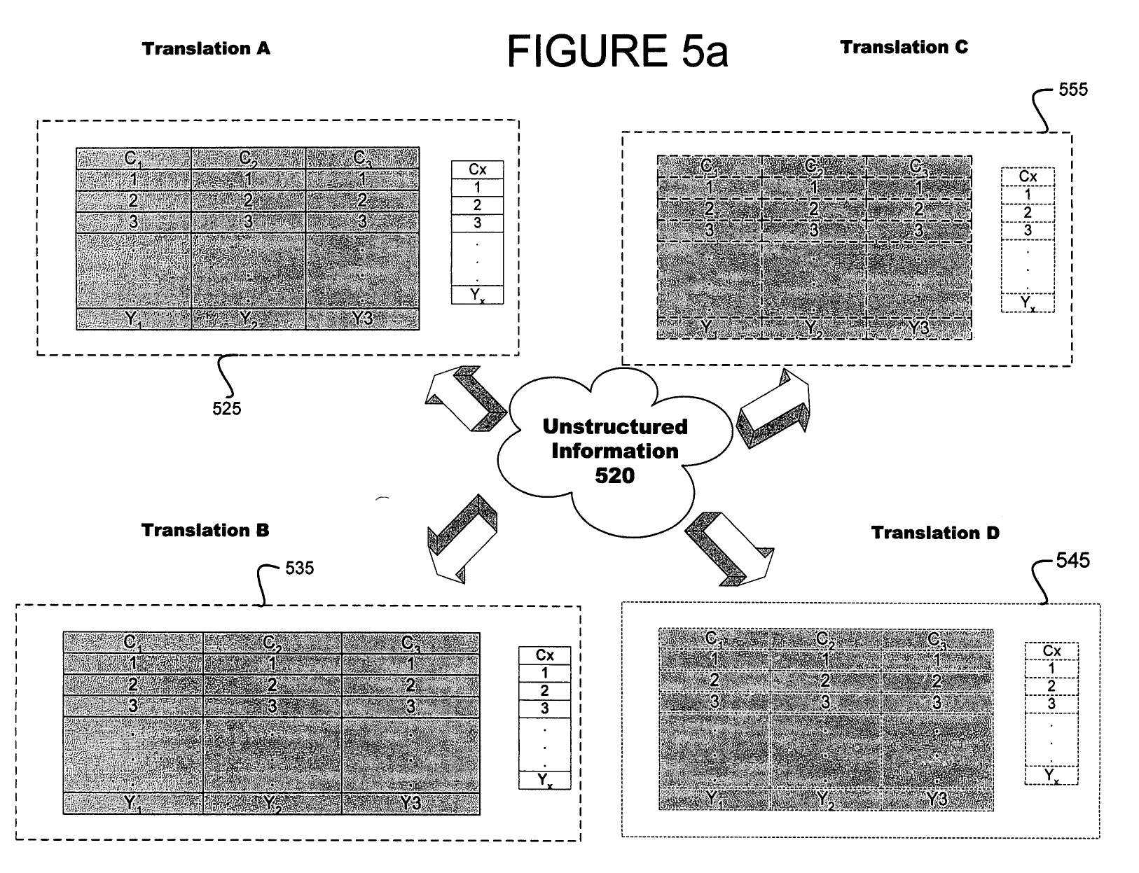

FIG. 5 is a block diagram a system 500 illustrating the compulsory nature of meta (or translation) language system 300. As shown, information processing system 104 may comprise a call center, for example, manned by “n” agents, 16, 17, 18, and 19. Each agent may receive incoming communications 102 for processing, such as phone calls, for example. According to one embodiment of the invention, each agent may use meta (or translational) language system 300 to translate incoming communications to translation 502, which may comprise any predetermined number of characteristics, which collectively comprise (or relate to) an organizationally relevant meaning(s). Notably, irrespective of which particular agent received the particular incoming communication, application of meta (or translational) language 300 ensures it will be specifically translated to translation 502. That is, unlike traditional languages (e.g., English), translation 502 is not susceptible to the particular translation (or vocabulary) skills of the individual agents, but is instead entirely based on the predetermined compulsory characteristics that reduce the incoming communication to organizationally relevant features. In other words, assuming the same incoming information or communication, translation 502 is replicable in an organizationally relevant way among the various agents, be they human, automated, or a collaboration of both.

In one embodiment agents 16, 17, 18, and 19 may comprise live human operators which interact with information processing system 104 to translate incoming communications. In this embodiment, the agents may manually assess and/or assign values to the particular characteristics which make up the meta (or translational) language system 300. In another embodiment, agents 16, 17, 18, and 19 may comprise automated systems or modules which operate to automatically assess and/or assign values to the particular characteristics which make up the meta (or translational) language system 300. In yet another embodiment, agents 16, 17, 18, and 19 may comprise a collaborative effort between live human operators and automated systems or modules to assess and/or assign values to the particular characteristics which make up the meta (or translational) language system 300.

FIG. 5a is a schematic illustration of how meta (or translational) language system 300 may be used to structure, interpret, or translate, for example, any form of unstructured information. Unstructured information 520 may comprise any form of information, data, or communication, for example, which is not in a recognizable or decipherable form. Meta (or translational) language 300 may, in one embodiment, be used to structure, interpret, or translate unstructured information into a predetermined number of characteristics (C₁, C₂, C₃, . . . , Cₙ), or parts of speech, which, in one embodiment, may relate to particular nuance(s) (inherent or incidental) of the unstructured information's meaning. As shown, there are four different translations of unstructured information 520: translation A, translation B, translation C, and translation D, represented by 525, 535, 545, and 555, respectively. In other words, meta (or translational) language system 300 may be used to effectively create any number of languages, each one suited to the user's particular needs and requirements.

That is, each characteristic may relate to a particular aspect or feature of meaning that is relevant or important to proper processing by the recipient of the translated information or communication, for example. Such aspects or features may be outwardly apparent, such as the sender or intended recipient of the information or communication, or may include incidental aspects or features such as the context, tone or mood in which the information is sent, presented or received, for example. Other aspects or features are possible.

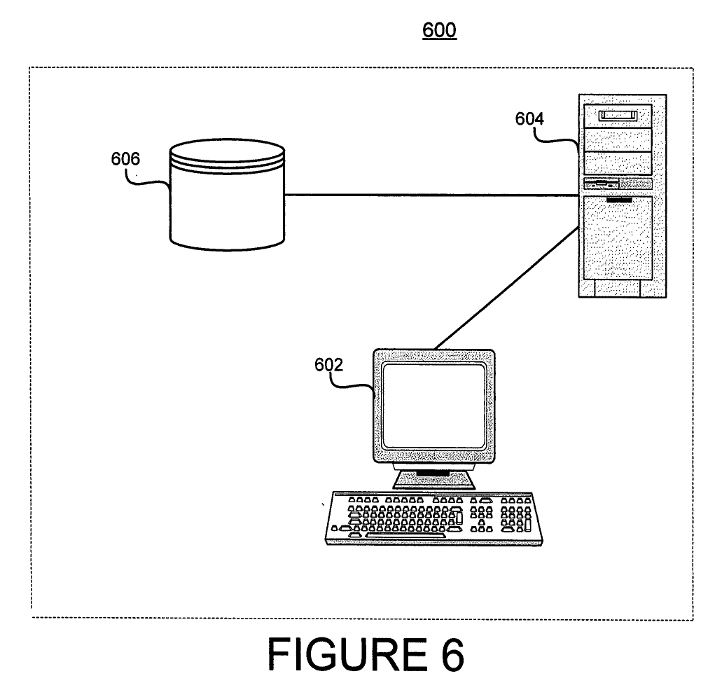

FIG. 6 is a block diagram of system 600 which may be used to implement or construct a meta (or translation) language system 300, according to one embodiment of the invention. In one embodiment, agents 16, 17, 18, and 19 of the call center example of FIG. 5 may interact with system 600 to assess and/or assign values to the particular characteristics which make up the meta (or translational) language system 300. In another embodiment, system 600 may also be used to construct meta (or translation) language system 300. In this embodiment, a system administrator, for example, may use system 600 to create a meta (or translational) language, such as by creating (i.e., defining) a predetermined number of characteristics relating to particular nuances of the information or communication, such as the context, tone or mood of the information or communication, for example.

Client station 602 may comprise or include, for instance, a personal or laptop computer running a Microsoft Windows™ 95 operating system, a Windows™ 98 operating system, a Millenium™ operating system, a Windows NT™ operating system, a Windows™ 2000 operating system, a Windows XP™ operating system, a Windows CE™ operating system, a PalmOS™ operating system, a Unix™ operating system, a Linux™ operating system, a Solaris™ operating system, an OS/2™ operating system, a BeOS™ operating system, a MacOS™ operating system, a VAX VMS operating system, or other operating system or platform. Client station 602 may include a microprocessor such as an Intel x86-based or Advanced Micro Devices x86-compatible device, a Motorola 68K or PowerPC™ device, a MIPS device, Hewlett-Packard Precision™ device, or a Digital Equipment Corp. Alpha™ RISC processor, a microcontroller or other general or special purpose device operating under programmed control. Client station 602 may further include an electronic memory such as a random access memory (RAM) or electronically programmable read only memory (EPROM), a storage such as a hard drive, a CDROM or a rewritable CDROM or another magnetic, optical or other media, and other associated components connected over an electronic bus, as will be appreciated by persons skilled in the art. Client station 602 may be equipped with an integral or connectable cathode ray tube (CRT), a liquid crystal display (LCD), electroluminescent display, a light emitting diode (LED) or another display screen, panel or device for viewing and manipulating files, data and other resources, for instance using a graphical user interface (GUI) or a command line interface (CLI). Client station 602 may also include a network-enabled appliance such as a WebTV™ unit, a radio-enabled Palm™ Pilot or similar unit, a set-top box, a networkable game-playing console such as a Sony™ Playstation™, Sega™ Dreamcast™ or a Microsoft™ XBox™, a browser-equipped or other network-enabled cellular telephone, or another TCP/IP client or other device.

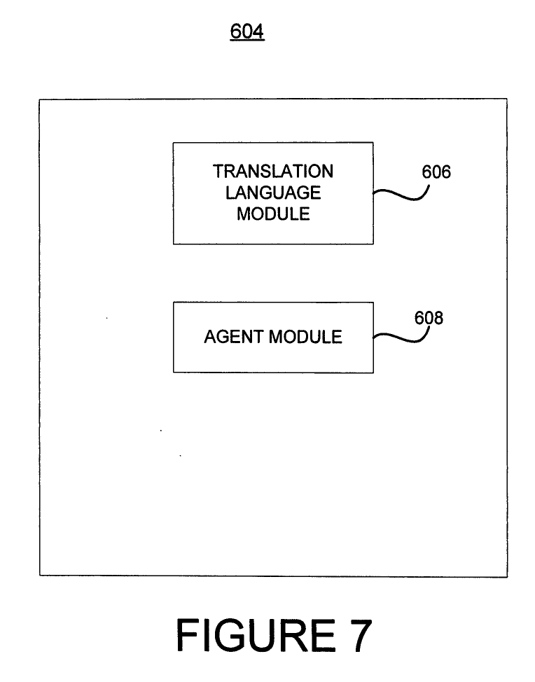

Server 604 may comprise a single server or engine (as shown). In another embodiment, Server 604 may comprise a plurality of servers or engines, dedicated or otherwise, which may further host modules for performing translation functionality described herein (See FIG. 7). Server 604 may include, for instance, a workstation or workstations running the Microsoft Windows™ XP™ operating system, Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2 operating system, the BeOS™ operating system, the Macintosh operating system, the Apache operating system, an OpenStep™ operating system or another operating system or platform.

Database 606 may comprise, include or interface to an Oracle™ relational database such as that sold commercially by Oracle Corporation. Other databases, such as an Informix™ database, a Database 2 (DB2) database, a Sybase database, an On Line Analytical Processing (OLAP) query format database, a Standard Query Language (SQL) format database, a storage area network (SAN), a Microsoft Access database or another similar data storage device, query format, platform or resource may be used. In one embodiment, database 606 may store information related to meta (or translational) language system 300, such as values for the predetermined number of characteristics (C₁, C₂, C₃, . . . , Cₙ), or parts of speech, as shown in FIGS. 3 and 4, for example. Such information may be entered and maintained, for example, by a system administrator using system 600 as described above. Information stored in database 600 may be updated or revised as necessary. Database 606 may also store particular business rules for handling information based on particular interpretations or translations based on meta (or translational) language system 300.

FIG. 7 is a block diagram of the server element of the meta (or translation) language system of FIG. 5. Server 604, for example, may host one or more applications or modules that function to permit interaction with live human agents as it relates to exchanging information related to the translation of information or incoming communications, for example. For instance, Server 604 may include a translation language module 606 for permitting a live agent to interact with, utilize, and compose, for example, meta (or translational) language system 300. Server 604 may also include an administration module that serves to permit interaction between the system and the individual(s) or entity(ies) charged with administering system 600, for example. A module for receiving unstructured information (not shown) may also be included. Other modules are of course possible.

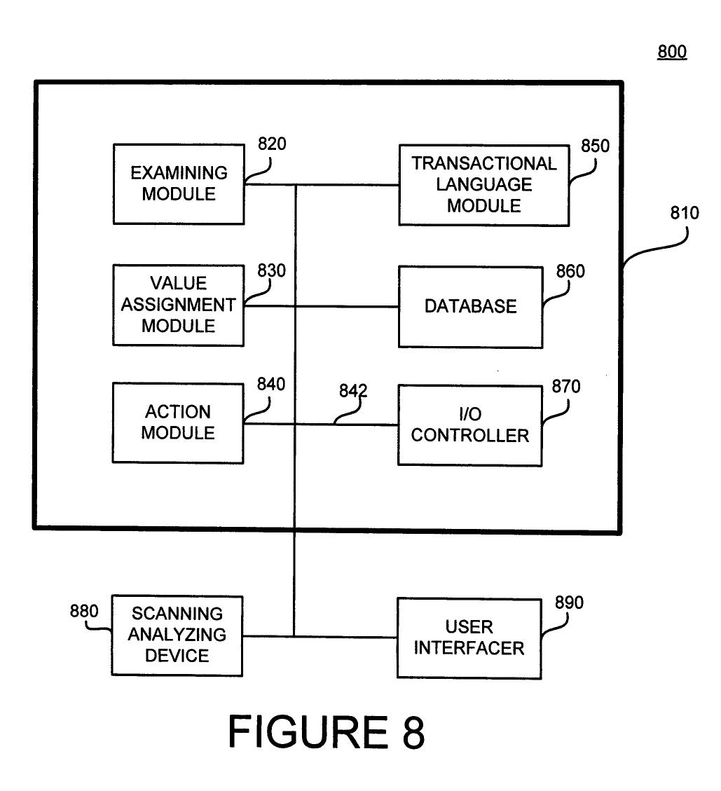

FIG. 8 is a block diagram illustrating one embodiment of an information processing system 800 utilizing both live human interaction and automated systems, according to one embodiment of the invention. System 800 may comprise an action determination module 810. The action determination module 810 is connected, via link 842, to one or more scanning/analyzing devices 880 and one or more user interfaces 890. For example, the scanning/analyzing device 880 can be any type of optical, electrical, electromechanical, inductive, or other system or combination of systems, that is/are capable of obtaining information about a scanned object. Likewise, the user interface 890 can be, for example, a computer, such as workstation, that is capable of displaying a graphical user interface, which, for example, receives user input (such as client station 602, for example). The action determination module 810 comprises an examining module 820, a value assignment module 830, an action module 840, a translational language module 850, a database 860, and an I/O controller 870, all interconnected by link 842.

In operation, an object is placed within the sensing area of the scanning/analyzing device 880. The scanning/analyzing device 880 can, for example, determine some preliminary identification of the object. For example, the scanning/analyzing device 880 can determine if the object is a piece of physical mail, an e-mail, an incoming phone call, content, or the like. Based on the sensed information, and in cooperation with the examining module 820, and the database 860, a preliminary identification of the object is made. Next, in cooperation with the I/O controller 870, the examining module 820 determines, for example, a graphical user interface that is forwarded to the user interface 890 to query a user for additional input regarding the sensed objected. For example, database 860 can store a plurality of profiles that are associated with objects that can be placed in the sensing area of the scanning/analyzing device 880. For example, as previously discussed in relation to FIG. 2, if a piece of physical mail, such as a letter, is placed in the sensing are of scanning/analyzing device 880, the graphical user interface presented to the user at interface 890, could be based on a profile and include, for example, the “To” “From” “Deliver” and “Type” fields (see FIG. 4) which prompt the user for additional information that will be associated with the value matrix.

These basic concepts regarding the profile associated with the sensed object can be expanded to include, for example, profiles associated within incoming calls, profiles associate with content, profiles with electronic communications or information, or the like. Thus, the combination of sensed information in supplemented by information input by user via user interface 890 allows the action determination module 810 to determine, for example, an action such as classification, a delivery method, a routing, an action, or the like, for the sensed object.

In particular, upon receiving the supplemental information via the user interface 890, the value assignment module 830, in cooperation with the database 860 and the 870 controller, associates the input information with characteristics that further define the object. Having received the sensed and supplemental information, the value assignment module 830, in cooperation with the translational language module 850 determines, if possible, an appropriate action for the object. Alternatively, if, for example, the value assignment module 830 queries the translational language module 850 for an action, and action is unable to be determined with the current amount of available information, the value assignment module 830, in cooperation with the examining module 820, can request further information from the user.

However, provided that there is sufficient information for action determination, the translational language module 850 applies a set of rules, such as handling procedures, to the values assembled in value matrix by the value assignment module 830. Having determined an appropriate action, such as a handling procedure, the translational language module 850, in cooperation with the action module 840, assigns an action to be taken with respect to the object. For example, the action can indicate to a user, what the user should do with the object. Alternatively, the process can be automated in that the action module 840 outputs the necessary instructions to control one or more devices that control one or more actions associated with the object. For example, in a simple embodiment, the actions can define the instructions associated with a mail sorting machine. As an alternative, an instruction can be placed on the user interface 890 that tells the user, such as an operator at a customer relations management call center, that an incoming call should be routed to, for example, a technical support specialist.

For example, in a content management environment, a book can be placed in the sensing area of the scanning/analyzing device 880. A user can then be queried for additional information, such as title, author and volume. Based on this information, the translational language module can determine a handling procedure, usage rights, accessibility (based on a security profile), or the like, such as returning the book to the shelves, placing a book on a reserved shelf, or the like.

As an alternative, for example, an operator at a customer relations management call center, as discussed above, can use the object management system 800 to assist in, for example, handling aspects of customer relations management and, for example, routing of content/information to the appropriate individual and/or department. For example, if a call is received, the sensed information may be the caller ID and/or name associated with the telephone number from which the call is being made. Then, the examining module 820, in cooperation with data base 860 and 110 controller 870 can determine, for example by querying a database to see if the caller is a customer who has made a recent purchase, an appropriate graphical user interface to display on the user interface 890. For example, the graphical user interface can have drop downs that correspond to, for example, departments within a department store such as: customer service, hardware, electronics, clothing, or the like. Then, upon the user selecting a “department,” further graphical interfaces can be dynamically populated to request additional information about the “object,” which in this case is an incoming call. This process continues until sufficient information has been assembled in the value matrix to which a rule can be applied.

Other exemplary systems that can be augmented by the object management system include but are not limited to usage rights systems, classification systems, object handling systems, warehouse management systems, records management systems, data handling systems, content providing systems, document handling systems, document archiving systems, indexing systems, such as web crawlers and spiders, access control system.

Likewise, these basic concepts can be applied to e-mail and response management systems. For example, the rules applied by the translation language module 850 can allow, for example, real-time dynamic processing of e-mails. For example, basic information such as date, time and sender can be sensed by the scanning/analyzing device 880. Then, for example, based on this basic information, the user can be prompted via a dedicated graphical user interface on user interface 890, to supply additional information that will be associated with the value matrix. For example, a user, upon scanning the e-mail, may be able to obtain information that the automated scanning/analyzing device 880 is unable to obtain. Therefore, a user can quickly tell whether the e-mail is requesting a meeting, requesting information, scheduling a telephone conference, or the like, which can then be appropriately assigned an action item, for example, populating a calendar with the meeting, assigning a task to reply to the information request, or the like. In some embodiments, the user merely describes or translates the content, while the assignment of an appropriate action or step is automated and/or based on pre-existing routing instructions, for example.

According to one embodiment of the invention, meta (or translational) language system 300 may also be used to assist fully automated information processing systems with translating information. Automated information processing systems typically deal with large volumes of information where live human handling of the entirety (or any significant portion) of the information is impractical due to either cost or time requirements. However, even the more sophisticated automated information processing systems sometimes fail to recognize, interpret or translate (i.e., process) all or some portion of the information. According to various embodiments of the invention, meta (or translational) language system 300 may be used in conjunction with these fully automated systems to “learn” (or refine its understanding of) proper translation, thus improving the percentage of incoming information that the overall system can correctly process. In one embodiment, this may be done by relying, entirely or in part, on human intervention.

According to one embodiment, information processing may comprise exception handling, which may involve an automated information processing system forwarding an unrecognized or unprocessable information or communication to a live human operator for translation and proper routing, for example. Preferably, the live human operator may interact with meta (or translational) language system 300 to accord proper translation. The automated information processing system may “learn” how to handle similar information or communications in the future based on the individual agent's response, as recorded and stored by the meta (or translational) language system. For example, an automated information processing system may fail to identify and categorize a particular communication through the dedicated automated means, such as a keyword-based automated processing engine, for example. In this situation, the automated information processing system may then forward the unknown and untranslated communication to a human agent using the envisioned meta (or translational) language system 300. Upon receipt of the information, the agent may translate the communication using system 300 and his or her highly developed contextual understanding faculties, and would forward the communication back into the automated processing system. The automated information processing system would then receive the translated information, review the keywords present, within the original communication, for example, note the human translation (i.e., the live agent's particular resolution), and look for similarities in future unprocessable communications.

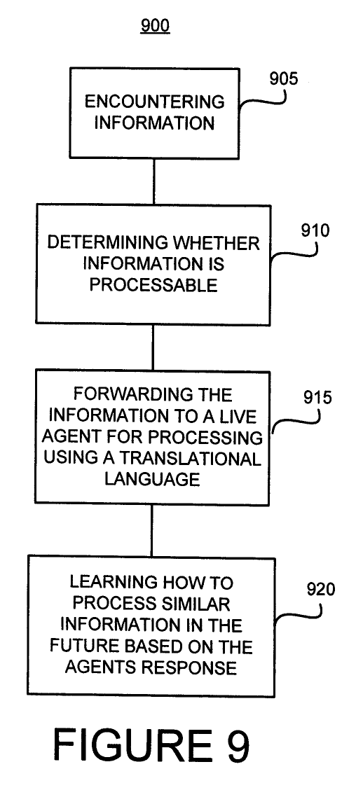

FIG. 9 is a flow chart process illustrating exception handling using an automated information processing system and meta (or translational) language system 300, according to one embodiment of the invention. At step 905, irregular information or communication is encountered by an automated information processing system. In one embodiment, irregular information or communication may comprise an incoming phone call to a call center. In another embodiment, irregular information or communication may comprise unstructured data stored in a database, for example. At step 910, information processing system determines whether the information is processable, i.e., whether it is recognizable. At step 915, information not recognized is forward to a live agent for processing. In one embodiment, the live agent may use meta (or translational) language system 300 to accurately translate or interpret the information into an organizationally relevant format. At step 920, the automated information processing system may learn how to translate similar incoming communications in the future based on the live agent's response.

According to another embodiment, information processing may comprise contemporaneous handling (or sampling), which may involve utilizing the meta (or translational) language system 300 to translate a percentage of the communications flowing through any given automated information processing system, but allowing human agents using the meta (or translational) language system 300 to refine the automated processing engine in an on-the-fly fashion, enabling the combined system to more quickly and intelligently respond to shifts in meaning and context in the underlying communication flows than a purely automated system. This collaborative approach allows for more accurate and improved translation.

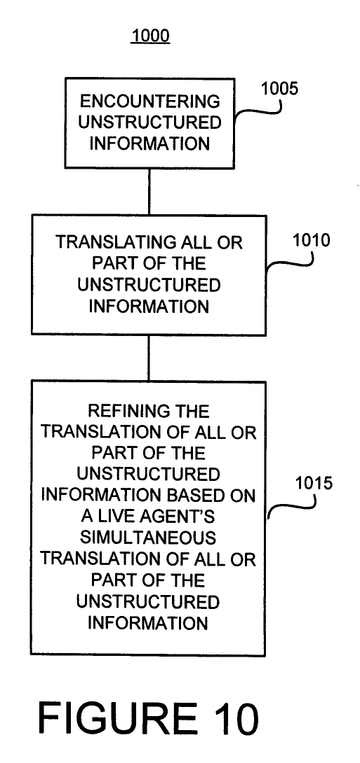

FIG. 10 is a flow chart process illustrating contemporaneous handling (or sampling), using an automated information processing system and meta (or translational) language system 300, according to one embodiment of the invention. At step 1005, unstructured information is encountered by an automated information processing system. In one embodiment, unstructured information may comprise an incoming phone call to a call center. In another embodiment, unstructured information may comprise unstructured data stored in a database, for example. At step 1010, automated information processing system translates all or a portion of the unstructured information. At step 1015, automated information processing system may refine all or part of the unstructured information based on a live agent's simultaneous translation of all or part of the unstructured information. In one embodiment, the live agent may use meta (or translational) language system 300 to accurately translate or interpret the information into an organizationally relevant format. In one embodiment, the automated information processing system may learn how to translate similar incoming communications in the future based on the live agent's response.

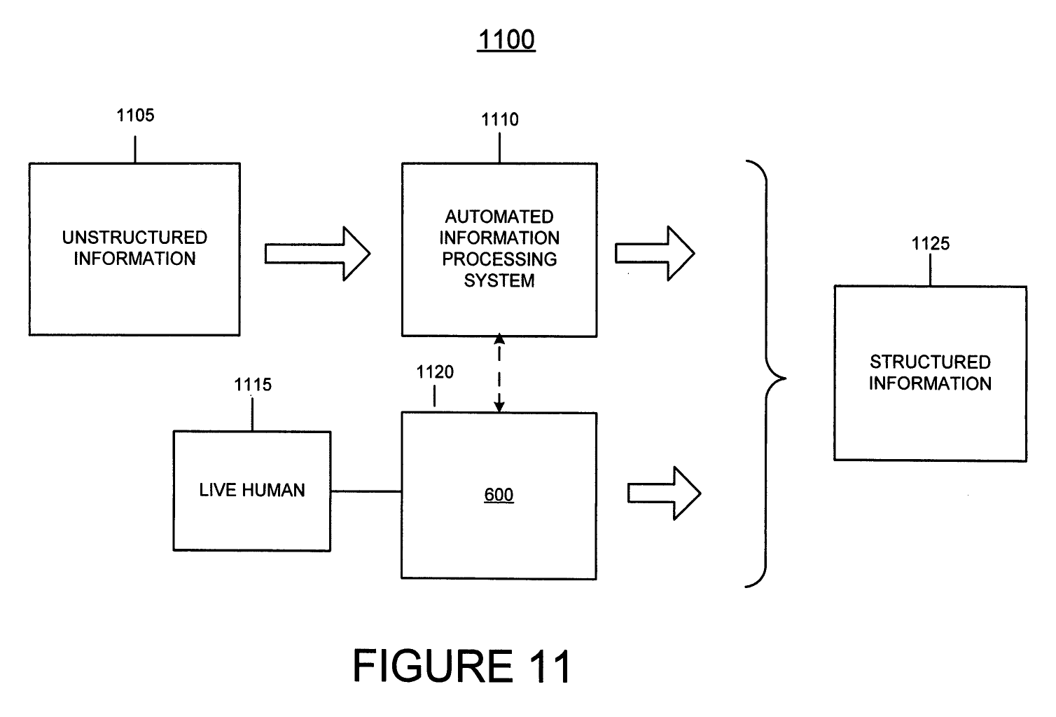

FIG. 11 is a schematic representation of a system 1100 employing exception handling and contemporaneous handling (or sampling), according to one embodiment of the invention. Unstructured information 1105 may be encountered by automated information processing system 1100. In the case of exception handing, automated information processing system 1110 may determine whether it recognizes the unstructured information. If it does not, it forwards it to system 600 (shown by 1120), which is manned by live agent 1115. In the case of contemporaneous handling (or sampling) automated information processing system 1110 translates all or portion of the unstructured information, while refining the translation, for example, based on the simultaneous translation of all or a portion of the unstructured information by live agent 1115 using system 600. In either exception handling or contemporaneous handling (or sampling), systems 1110 and 600 collaborate to produce structured information 1125.

The following are various exemplary embodiments of the systems and methods described above.

According to one embodiment, an automated internet search process copies and processes messages with certain keywords from chat rooms, emails, websites, user groups, BBS, online gaming environments, and other forums of online communication. The majority of these messages would be processed automatically, while a portion, including but not limited to all unprocessable or unintelligible messages, would be routed to a live agent or group of live agents for human interpretation using meta (or translational) language system 300. Each instance of human interpretation and translation would be fed back into the automated process, analyzed for similarities and resolution for use in future automated processing. This would help the automated system adapt to changes in context, language, and new themes in the messages more quickly and accurately, and may provide assurance that a human set of eyes is tracking and correcting the overall work of the automated system.

According to another embodiment, information processing may comprise partially automated systems comprised of both machine processes and a live agent or live agents using meta (or translational) language system 300 to evaluate, categorize, or otherwise process a group of white papers, published articles, advertisements, due diligence information, or other documents or document-type files in order to classify and assign metadata to each. Metadata in this example may comprise values assigned to categories such as “content”, “company”, “author”, “size”, “location”, etc., for example.

According to another embodiment, information processing may comprise a combined system of interactive voice (or touchtone) response (IVR) telephone call processing system and humans, for a government “411” call center, for example, or a large corporate receptionist pool for another example. Callers would initially be greeted with an automated IVR system to allow them to provide information about why they are calling, or what question they might have. Callers that prefer to deal with humans could opt-out of the system and be delivered to a live agent using meta (or translational) language system 300 to translate the issue espoused by the caller into a form that can be handled and understood within the called organization's call management and workflow process structure. Additionally, callers that espouse any issue or message or question that cannot be handled correctly under the existing IVR system set-up could similarly be delivered to a live agent for processing. The permutative and expansive characteristics of meta (or translational) language system 300 enables live agents to process a vastly broader set of message or communication types than practicably permissible in an IVR system, due to the necessity for the IVR system to “orally” list each possible classification option.

According to another embodiment, information processing may comprise a combination of two distinct examples of object management system 800, for example, working together to classify types of “normal” or “hard” mail pieces, and route them according to the automated requests of the potential recipients, with a portion or all of the pieces being opened, extracted, tested, scanned, digitized, and emailed or otherwise delivered digitally to the appropriate security-cleared live agent using meta (or translational) language system 300 for content classification and final routing and workflow. For instance, in an environment that receives an enormous quantity of mail in which there are concerns for safety and responsiveness, such as the U.S. House of Representatives for example, the outside of mail pieces can be scanned using automated devices and processes to determine, for example, that a particular piece of mail is addressed to a particular Representative's Office, is first class mail, in an envelope of standard size, with an unrecognized return address, and a zip code from within the Representative's constituency. In this example, the Representative may want such pieces of mail opened, tested for anthrax spores and other pathogens, digitally scanned, and the image of the contents emailed to his or her personal office staff for translation. When the image of the contents, in this example a letter from a constituent, arrives via email or other electronic information delivery process to the workstation of the appropriate office staff member, he or she uses meta (or translational) language system 300 to translate the letter. Based on that translation, the appropriate workflow process previously designated by the Representative or his office staff may be carried out. For example, a response letter to the constituent might be automatically generated in the Representative's constituent response tracking application, printed out, presented to the Representative for his signature and mailed to the constituent.

According to another embodiment, information processing may comprise a live agent, such as a medical nurse, doctor, or other health professional, for example, examining a patient, or speaking over the telephone, over “instant messenger”, or other communication system, with a person complaining of a medical malady. The live agent would use meta (or translational) language system 300 to translate the important communicated facts, including perhaps the patient's symptoms, age, weight, name, social security number, allergies, location, etc. Upon translation using system 300, the information processing system 800, for example, may automatically pull the appropriate data from one or more automated databases, such as health databases, actuarial risk tables, insurance coverage calculator, hospital locator, enterprise resource planning (ERP) system, Global Positioning Systems, Emergency Service personnel locators, or other systems, and would correlate the information in the manner determined beforehand by the appropriate health professionals in order to direct the live agent on the appropriate course of action or recommendation.

According to another embodiment, information processing may comprise a live agent responding to and routing communications, whether over the telephone, in person, or using other communication systems, that are too important to rely upon automated systems to handle. For example, a poison control hotline, product liability hotline, or other agent or group of agents receiving communications including potential life-or-death matters might be considered by the organization receiving the communications to be too important to greet callers with an automated communication system.

According to another embodiment, information processing may comprise a live agent reviewing an item of merchandise, or a service, in order to assign relevant metadata using meta (or translational) language system 300. For example, a large retail store with the capability of suggest-selling to its customers, i.e., that proffers items to each customer that are similar in some aspect to items that the customer has bought before, for instance, would use a live agent to assign metadata as mentioned above to classify and assign metadata to individual types of merchandise in inventory in order to describe the merchandise in a way that allows the automated suggest-sell system to suggest relevant and attractive merchandise to every possible customer. This system could be used in conjunction with, or to enhance, purely automated systems, for instance, one that links items by the frequency one type was purchased with another particular type.

According to another embodiment, information processing may comprise a live agent or team of live agents using meta (or translational) language system 300 to mine data from individual documents, white papers, etc., i.e., record specific points contained within the text of each document. This processing could be done, in one embodiment, alongside an automated collative process that enables easy access to the individually described points or sections of the text for later review or research.

According to another embodiment, information processing may comprise a live agent or team of live agents utilizing an information processing system 800, for example, to better manage customer relationships [e.g. Customer Relationship Management (CRM) system] by making each customer communication part of a workflow and response management system to maximize the efficiency and the customer-friendly ability of the responding organization. In this embodiment, a caller might place a telephone call into the organization to check on the status of an order, for instance. The live agent would use meta (or translational) language system 300 to interpret the words the caller uses, creating organizationally useful information that would automatically drive the next step as directed by the organization, whether that step be to generate a query to the shipping system, to prompt the live agent with the appropriate information to respond verbally, or to generate a follow-up email with the information once the information becomes available, or some combination of those actions as appropriate, for example.

According to another embodiment, information processing may comprise a live agent or group of live agents, working for a law firm for example, receiving communication of inquiry or complaint from potential clients via any method of communication, such as via telephone for example. The potential client would describe the particulars of his or her inquiry or situation, and the live agent handling the communication would use meta (or translational) language system 300 to describe or classify the relevant particulars of the communication. The accompanying automated system would then utilize databases or other automated services, as well as the predetermined communication response management set-up of the organization, to suggest or dictate to the live agent the best response path, for example. This embodiment would have equal applicability to other service providers in addition to law firms, including but not limited to telephone hotlines, online chat rooms, websites, emails, “instant messaging”, face-to-face meetings, and other communication forums for such entities and organizations as crisis help, support groups, advice services, plumbers, electricians, telephone repair services, billing groups, Personal Computer help desk-type services, investment management, government “411” installations, and other providers of information, products, or services.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

1. A translation language for structuring irregular information, comprising:
at least one compulsory characteristic for defining a particular nuance of an irregular communication; and
at least one term or phrase corresponding to the at least one compulsory characteristic for further defining the particular nuance of the irregular communication.

2. The translation language of claim 1 wherein the at least one compulsory characteristic and the at least one term or phrase are in a predetermined relationship.

3. The translation language of claim 1 wherein the predetermined relationship determines the granularity of the translation language.

4. The translation language of claim one wherein the at least one compulsory characteristic relates to at least one organizationally relevant meaning.

5. The translation language of claim 4 wherein the at least one term or phrase corresponding to the at least one compulsory characteristic further defines the at least one organizationally relevant meaning.

6. The translation language of claim 1 wherein the at least one compulsory characteristic is determined by a live human agent.

7. The translation language of claim 1 wherein the at least one term or phrase is determined by a live human agent.

8. The translation language of claim 1 wherein the irregular communication comprises unstructured data.

9. The translation language of claim 1 wherein the at least one compulsory characteristic and the at least one term or phrase corresponding to the at least one compulsory characteristic collectively define a particular meaning of the irregular information.

10. A system for structuring information, comprising:
means for encountering information; and
means for structuring the information by translating or interpreting it using a translation language.

11. The system of claim 10 wherein the means for encountering information comprises an information processing system.

12. The system of claim 11 wherein the information processing system comprises in whole or in part a meta (or translational) language system.

13. The system of claim 10 wherein the translation language comprises a predetermined number of compulsory characteristics relating to particular nuances of the unstructured information.

14. The method of claim 10 wherein the means for encountering information comprises an information encounter module.

15. A process for structuring unstructured information, comprising:
receiving unstructured information; and
structuring the unstructured information by translating it using a translation language, the translation language comprising a predetermined number of compulsory characteristics relating to particular nuances of the unstructured information.

16. The process of claim 15 wherein the each compulsory characteristic relates to a part of speech having a particular vocabulary.

17. The process of claim 15 wherein the predetermined number of compulsory characteristics is based on the granularity desired for the translation language.

18. The process of claim 15 wherein the values of each predetermined compulsory characteristic is determined by a live operator.

19. The process of claim 15 wherein the predetermined compulsory characteristics act in concert (i.e., collectively) to define the meaning of the previously unstructured information.

20. A process for structuring information, comprising:
receiving information content in a first language; and
translating the information content to a second language by associating at least one particular nuance of the information's content to at least one part of the speech of the second language.

21. The process of claim 20, wherein the parts of speech in the second language act in concert (i.e., collectively) to define the meaning of the information.

22. A process for structuring communication or information using a translation language, comprising:
creating at least one part of speech of a translational language for use in translating incoming information; and
associating at least one particular nuance of the incoming information with the at least one part of speech.

23. The process of claim 22 further comprising the step of structuring the communication or information by determining a particular meaning.

24. The process of claim 22 wherein said meaning is determined based on the association of the at least one particular nuance of the incoming information with the at least one part of speech.

25. A method for structuring communication/information, comprising:
receiving information/communication in a first language;
translating the information/communication to a finite number of characteristics in a second language based on the information/communication's content; and
structuring the information/communication based on the particular combination of characteristics.

26. The method of claim 25 wherein the structured information/communication has a predetermined meaning or significance.

27. The method of claim 25 wherein the finite number of characteristics have a corresponding vocabulary.

28. The method claim 27 wherein the finite number of characteristics and corresponding vocabulary define a predetermined number of potential meanings or translations.

29. The method of claim 25 wherein the structure of the information/communication comprises a meta (or translational) language.

30. A process for translating an incoming communication, comprising:
receiving a communication;
winnowing the communication down to a predetermined number of characteristics using a translation language, the translation language comprising a predetermined number of organizationally relevant compulsory characteristics relating to particular nuances of the unstructured information; and
determining the meaning of the incoming communication based on the predetermined number of organizationally relevant compulsory characteristics.

31. The process of claim 30 wherein determining the meaning of the incoming communication comprises resolving the predetermined number of organizationally relevant compulsory characteristics against at least one predetermined business rule.

32. The process of claim 30 wherein the winnowing step is performed by a live agent.

33. The process of claim 30 wherein the predetermined number of organizationally relevant compulsory characteristics each have a corresponding vocabulary.

34. The process of claim 30 wherein the communications comprises unstructured data.

35. A method for translating incoming communications, comprising:
receiving an incoming communication;
forwarding the incoming communication to a live operator for translation; and
learning how to translate similar incoming communications in the future using a translation language, the translation being based on the live operator's resolution.

36. The method of claim 35 wherein the incoming communication is examined prior to being forwarded to the live operator for translation.

37. A process for structuring information, comprising:
encounter unstructured information;
determining whether the unstructured information is processable;
forwarding the information to a live agent for processing using a translational language; and
learning how to process similar unstructured information in the future based on the live agent's resolution.

38. The process of claim 37 wherein the unstructured information comprises unstructured data.

39. The process of claim 37 wherein the translation language comprises a predetermined number of compulsory characteristics relating to particular nuances of the unstructured information.

40. A method for processing incoming communications, comprising:
receiving an incoming communication;
translating all or part of a percentage of the incoming communication using a human agent utilizing a translation meta language, the translation meta language comprising a predetermined number of compulsory characteristics relating to particular nuances of the unstructured information;
assessing how the incoming communication has been or is being processed by the human agent or other human operators; and
refining all or part of the automated translation system based on such assessment.

41. A method for structuring information, comprising:
encountering unstructured information;
translating all or part of the unstructured information; and
refining the translation of all or part of the unstructured information based on a live agent's translation of all or part of the unstructured information.

42. The process of claim 41 wherein the unstructured information comprises unstructured data.

43. The process of claim 41 wherein the translation language comprises a predetermined number of compulsory characteristics relating to particular nuances of the unstructured information.

44. The process of claim 41 wherein the live agent's translation occurs simultaneously.

45. The process of claim 41 wherein the refined translation is stored for future access.

46. A method for translating recursive information comprising:
encountering recursive information;
translating all or part of the recursive information; and
refining the translation of all or part of the recursive information based on a live agent's translation of all or part of the recursive information.

47. A method for structuring information, comprising:
encountering audio or visual information; and
translating all or part of the audio or visual information using a translation language.

48. The method of claim 47 wherein the audio or visual information comprises any number or combination of images, moving pictures, diagrams, songs, spoken words, or other noises.

49. A method for systematically describing and structuring information, comprising:
encountering audio or visual information; and
describing or classifying the said information using a meta (or translational) language system in order to improve accessibility and utility of said information.

50. A system for structuring information, comprising:
means for encountering audio or visual information; and
means for translating all or part of the audio or visual information using a translation language.

51. A method for processing a search request, comprising:
receiving a request for information from a user;
translating the request for information into an organizationally relevant format;
resolving the organizationally relevant format against a database of information; and
providing the user with information responsive to the request for information.

52. A system for processing information, comprising:
a reception module for receiving incoming audio or visual information; and
a translation module for translating the incoming audio or visual information using a translation language.

53. A system for processing a request for information, comprising:
a reception module for receiving a request for information; and
a refining module for refining the search request to an organizationally relevant format using a translation language.
